(19) United States
(12) Patent Application Publication
(10) Pub. No.: US 2026/0228700 A1
(43) Pub. Date: Aug. 6, 2026

(54) Calendar Projecting Device and Method of Use

(71) Applicant: Larry Winder, Jr., Gwynn Oak, MD (US)

(72) Inventor: Larry Winder, Jr., Gwynn Oak, MD (US)

(21) Appl. No.: 19/215,977

(22) Filed: May 22, 2025

Related U.S. Application Data
(60) Provisional application No. 63/748,494, filed on Jan. 23, 2025.

(51) Int. Cl. G06Q 10/1093; G03B 21/14; G06F 1/16; G06F 3/16

(52) U.S. Cl. CPC G06Q 10/1093; G03B 21/142; G03B 21/145; G06F 1/1605; G06F 3/167

(57) ABSTRACT

A digital calendar projecting device for wirelessly receiving, generating, and projecting customizable calendar content onto flat or planar surfaces, such as walls or ceilings, is disclosed. The device includes a main body mounted on a base and integrates an HD projection lens. A processor controls projection operations based on input from a wireless communication module and a rechargeable power source. The device receives calendar data from a paired electronic device via wireless protocols such as Wi-Fi or Bluetooth, or generates standalone calendar views. A built-in microphone captures user voice commands, which a natural language processing module interprets to control projection settings and entry items. Users can customize calendar views and visual themes through voice commands or a companion mobile application. The device renders and projects the selected calendar layout, enabling interactive, hands-free, or app-controlled display of digital calendars in real time or as standalone views.

### CROSS REFERENCE TO RELATED APPLICATION

The present application claims priority to, and the benefit of, U.S. Provisional Application No. 63/748,494, which was filed on Jan. 23, 2025, and is incorporated herein by reference in its entirety.

### FIELD OF THE INVENTION

The present invention generally relates to digital display devices. More specifically, the invention relates to a portable calendar projecting device configured to wirelessly receive, generate, and display calendar information in a compact and non-intrusive manner. The invention comprises a circular main body supported by a base, incorporating a high-definition projection lens operatively coupled to a micro-projector module. The device further includes an integrated wireless module, processor, rechargeable power source, and a voice-activated control system for hands-free operation. Users may transmit calendar data via a paired mobile application or issue voice commands to trigger projection of customizable calendar views on walls, ceilings, or other flat or planar surfaces. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals use calendars for tracking dates, scheduling appointments, and remembering special events. However, conventional calendars are commonly printed on paper and come in various forms, including wall-mounted calendars, desk calendars, and pocket-sized planners. While useful, paper calendars present several drawbacks in modern living and working environments.

First, physical calendars occupy space and require placement on a wall, desk, or other flat or planar surface. In environments with limited available space, such as compact offices, shared workspaces, or minimalist home settings, allocating space for a calendar can be inconvenient. Additionally, individuals often purchase multiple calendars for different rooms or purposes, which can lead to unnecessary clutter or redundant use. Moreover, physical calendars lack adaptability and interactivity. They do not update automatically with changing schedules or synchronizing with digital tools commonly used today. Users may forget about calendars they have purchased or fail to keep them updated, reducing their practical value and increasing waste. Also, older individuals and individuals with eye defects cannot access the calendars on their electronic devices easily and conveniently, and calendars in electronic devices do not provide the ease of big calendars placed on walls. Accordingly, individuals desire a compact, intelligent, and interactive solution that offers the functionality of a calendar without the spatial and environmental drawbacks associated with traditional paper calendars.

Therefore, there exists a long-felt need in the art for a portable, lightweight digital calendar solution that eliminates the limitations associated with traditional paper calendars. There is a long-felt need for a compact device that can display calendar information in a space-efficient manner without requiring physical installation on walls or desks. Additionally, there is a long-felt need for a digital calendar system that synchronizes with electronic devices to reflect real-time updates. Furthermore, there is a long-felt need for a hygienic, touch-free calendar display method that can be activated via voice commands or remotely through a mobile application. More specifically, there is a long-felt need for a device that enables users to conveniently view, customize, and manage calendar information without relying on traditional physical formats. Finally, there is a long-felt need in the art for an interactive, projection-based calendar that provides a combination of digital utility and minimalistic design for both home and office environments.

The subject matter disclosed and claimed herein, in one embodiment, comprises a digital calendar projecting device designed to wirelessly receive, generate, and project calendar content onto walls, ceilings, or other flat or planar surfaces. The device comprises a main body supported by a base, wherein the main body houses a high-definition (HD) projection lens operatively connected to a micro-projector module. The device further includes a processor, a wireless communication module, a microphone, and a rechargeable or plug-in power source. The wireless module enables the device to connect to electronic devices such as smartphones or tablets and receive real-time calendar updates. Upon receiving a command, either through a mobile app or a spoken voice input, the device projects the corresponding calendar view (daily, weekly, or monthly, yearly) onto a nearby surface, with customizable display themes and adjustable focus settings.

In another embodiment, the projection lens is coupled with an adjustable cap to fine-tune projection angle and focus depending on room layout and lighting conditions. The device may also include software integration with major calendar platforms such as Google Calendar, Apple Calendar, and Microsoft Outlook calendar, enabling seamless synchronization and remote control via companion applications.

In this manner, the digital calendar projecting device of the present invention fulfills the long-felt need for an elegant, efficient, and interactive alternative to traditional calendars. The device offers users a clutter-free way to view and manage calendar information while integrating with their existing digital ecosystem. The device provides users with a technologically advanced calendar that can be projected onto a flat or planar surface. The device eliminates the need for paper and physical calendars, offering a much more efficient option for keeping track of special dates, meetings, events, and more. The device enables users to program the calendar via software on a smartphone, laptop, or other smart device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a digital calendar projecting device. The digital calendar projecting device comprises a main body having a substantially circular shape, a projection lens is disposed on a front surface of the main body, the projection lens being an HD lens operatively coupled to a micro-projector module for projecting a digital calendar onto a flat or planar surface, a base for stably supporting the main body on a surface, a wireless module is configured to receive calendar data from at least one external electronic computing device via a wireless communication channel, and a processor is operatively connected to the micro-projector module and is configured to render the received calendar data for projection.

In another aspect, a system for digital calendar projection is disclosed. The system comprises a digital calendar projecting device including a projection lens and a processor, a microphone is operatively configured to capture voice commands from a user, a natural language processing module is configured to interpret the voice commands, wherein the processor is configured to control projection of a digital calendar onto a wall or other flat or planar surface in response to the interpreted voice commands, and wherein the projection lens is adjustable via an adjustment mechanism to change focus and angle based on surface characteristics.

In another embodiment, a digital calendar projecting system is disclosed and comprises a calendar projecting device including a processor, wireless module, and projection lens, a software application is executable on a remote electronic device, the software application is configured to wirelessly transmit calendar data and customization commands to the calendar projecting device, wherein the calendar projecting device is configured to display a calendar on a surface, the display being customizable with themes, fonts, colors, and layout types, and wherein the device reflects real-time updates from third-party calendar applications synchronized with the remote electronic device.

In one embodiment, a method for projecting a digital calendar using a calendar projecting device is disclosed. The method includes setting up and powering on the calendar projecting device, wirelessly connecting the calendar projecting device to at least one electronic computing device using a wireless communication protocol, receiving, at the calendar projecting device, a command to project a calendar, the command is received from a software application executed on the electronic computing device, processing the received command using a processor embedded in the calendar projecting device, and projecting the customized calendar onto a flat or planar surface using an HD projection lens coupled to a micro-projector module.

In yet another aspect, the wireless communication protocol is selected from the group consisting of Wi-Fi, Bluetooth, Zigbee, Z-wave, LoRA, and LoRAWAN.

In still another embodiment, the device automatically switches between a standalone calendar mode and a synchronized calendar mode, wherein the switching is based on the detection of a connection with the electronic computing device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the digital calendar projecting device of the present invention in accordance with the disclosed structure;

FIG. 2 illustrates a schematic view showing the wireless coupling of the digital calendar projecting device of the present invention with an electronic device in accordance with the disclosed architecture;

FIG. 3 illustrates a perspective view showing a user giving a voice command to the calendar projecting device in accordance with one embodiment of the present invention;

FIG. 4 illustrates a perspective view showing a digital calendar being displayed by the calendar projecting device of the present invention in accordance with the disclosed structure;

FIG. 5 illustrates a flow chart depicting a process of use of the calendar projecting device in accordance with the disclosed structure. Initially, a user sets up and powers on the smart calendar device; and

FIG. 6 illustrates a rear view of the calendar projecting device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a portable, lightweight digital calendar solution that eliminates the limitations associated with traditional paper calendars. There is a long-felt need for a compact device that can display calendar information in a space-efficient manner without requiring physical installation on walls or desks. Additionally, there is a long-felt need for a digital calendar system that synchronizes with electronic devices to reflect real-time updates. Furthermore, there is a long-felt need for a hygienic, touch-free calendar display method that can be activated via voice commands or remotely through a mobile application. More specifically, there is a long-felt need for a device that enables users to conveniently view, customize, and manage calendar information without relying on traditional physical formats. Finally, there is a long-felt need in the art for an interactive, projection-based calendar that provides a combination of digital utility and minimalistic design for both home and office environments.

The present invention, in one exemplary embodiment, is a digital calendar projecting system and comprises a calendar projecting device including a processor, wireless module, and projection lens, a software application is executable on a remote electronic device, the software application is configured to wirelessly transmit calendar data and customization commands to the calendar projecting device, wherein the calendar projecting device is configured to display a calendar on a surface, the display being customizable with themes, fonts, colors, and layout types, and wherein the device reflects real-time updates from third-party calendar applications synchronized with the remote electronic device.

Reference will now be made in detail to the present preferred embodiments of the invention, examples of which are illustrated in the accompanying drawings. Wherever possible, the same reference numerals are used in the drawings and the description to refer to the same or like parts.

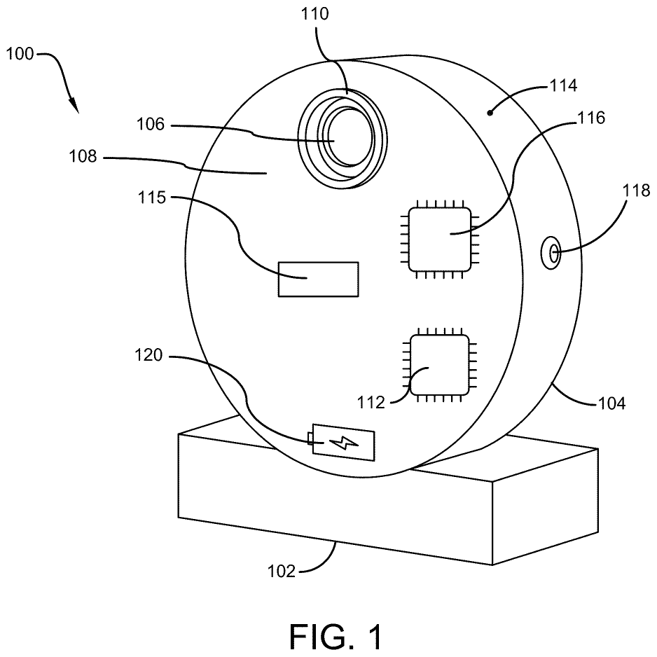

Referring initially to the drawings, FIG. 1 illustrates a perspective view of the digital calendar projecting device of the present invention in accordance with the disclosed structure. The digital calendar projecting device 100 of the present invention is designed as an electronic device that projects a digital calendar onto walls, ceilings, or other flat or planar surfaces. The digital calendar projecting device 100 is portable, lightweight, and can be paired wirelessly with at least one electronic computing device for receiving calendar information for projection. More specifically, the digital calendar projecting device 100 has a stand or base 102 to keep the device 100 stable on a horizontal surface such as a desk, table, or shelf.

A main body 104 of the digital calendar projecting device 100 is preferably circular and is designed to be accommodated (i.e., mountable) on the base 102. The main body 104 is made from lightweight, durable plastics or metal composite for durability and portability. A projection lens 106 is disposed in the front surface 108 of the main body 104. The projection lens 106 is in the form of a HD lens and is configured for high-definition (HD) projections for sharp and clear calendar images. The projection lens 106 is adjustable using an adjustable cap 110 for adjusting focus and angle to project on different types of planar surfaces. The projection lens 106 is operatively coupled to a micro-projector module 112 embedded inside the main body 104. The device 100 can use DLP (Digital Light Processing) or LCOS (Liquid Crystal on Silicon) projection technology for compatibility with different lighting levels.

A microphone 114 is included in the device 100 for capturing voice messages from users. A natural language processing module 115 of the device 100 can interpret voice commands captured by the microphone 114 to customize the calendar display based on the voice commands. As a non-limiting example, a “Display current month” voice command may enable the device 100 to display the current month calendar. Another non-limiting example includes a voice command to add, modify, or delete a calendar entry item.

A processor 116 embedded in the device 100 is configured to control the calendar projection rendering from the projection lens 106 based on processed voice commands and wireless signals received from a coupled electronic device. The processor 116 is also adapted to generate customizable calendar views such as weekly, daily, and monthly, along with theme selections such as different colors, fonts, and designs.

A wireless module 118, such as Wi-Fi or Bluetooth module, is included in the device 100 for receiving calendar information from coupled electronic devices and for receiving software updates, such as receiving new themes, fonts, and more. A replaceable and rechargeable battery 120 is included in the device 100 for providing electrical power to the device 100. The battery 120 can be a Li-Ion battery or button battery, depending on the design and size of the calendar projecting device 100. In some embodiments, the device 100 may operate using a direct plug-in power source such as a regular wall-mounted power socket.

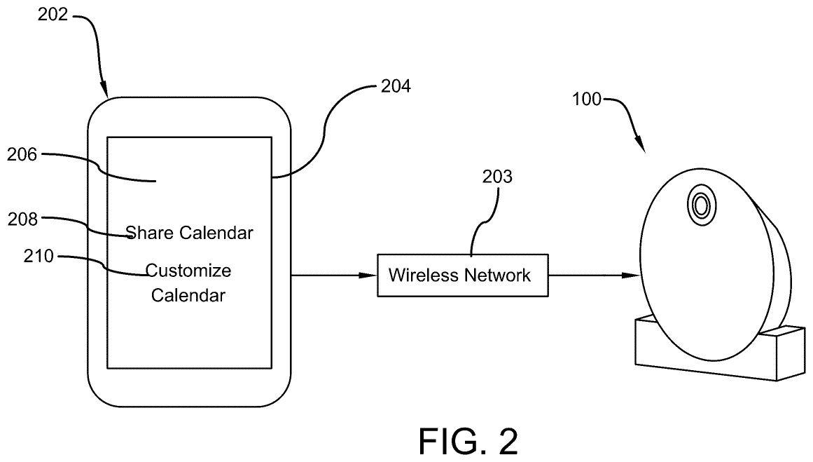

FIG. 2 illustrates a schematic view showing the wireless coupling of the digital calendar projecting device of the present invention with an electronic device in accordance with the disclosed architecture. The device 100 is coupled wirelessly to the electronic device 202 using a wireless channel 203 such as Wi-Fi, Bluetooth, Zigbee, Z-wave, LoRA, LoRAWan, or any other conventional wireless communication technology. The device 100 can be any conventional electronic computing device, such as a handheld device like smartphone, tablet, laptop, and more. The electronic device 202 includes a software application 204 which is configured to provide a plurality of options for controlling operations of the device 100.

The application 204 provides an Activation option 206 for remotely activating and deactivating the calendar projecting device 100. The processor 116 of the device 100 receives the wireless activation signal from the electronic device 202 via the wireless module 118 for processing and to activate or deactivate the device 100. A “Share calendar” option 208 enables a user to share a digital calendar from the electronic device 202 to the calendar projecting device 100 for projection on a wall or on any surface. The calendar is shared in real-time, and the projected calendar from the device 100 reflects the real-time changes being made in the calendar in the electronic device 202. The calendar projecting device 100 is compatible and integrated with various calendar applications such as Google Calendar, Outlook Calendar, Apple Calendar, and more. It is to be appreciated that the electronic device 202 includes a memory for storing past, present, and future calendars for viewing and for historical reference.

A “Customize Calendar” option 210 enables users to customize the theme, design, color, font, and more of the projected calendar. The processor 116 of the calendar projecting device 100 receives the customized options and accordingly customize the projected calendar. The option 210 also adjusts the position of the adjustable cap 110 for adjusting focus and angle to project on different types of surface.

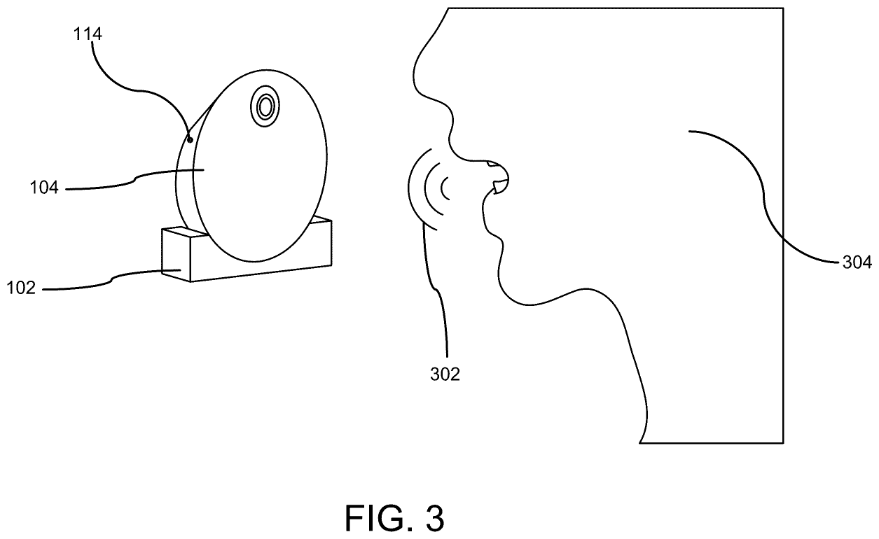

FIG. 3 illustrates a perspective view showing a user giving a voice command to the calendar projecting device in accordance with one embodiment of the present invention. The device 100 is configured to capture voice command 302 from the user 304 when the voice command 302 is spoken from within a predetermined distance, such as two meters from the device 100. The captured voice command 302 is processed by the natural language processing module 115 (shown in FIG. 1), and the processor 116 instructs the projection lens 106 to project a calendar based on the voice command.

It should be noted that the calendar projecting device 100 can also generate a basic standalone calendar (such as day, week, month, and year layout) without needing a paired device. The basic standalone calendar is generated based on embedded clock and date mechanism of the processor 116. Also, as described in FIG. 2, the calendar projecting device 100 can synchronize with third-party calendar services including, but not limited to, Google Calendar, Apple Calendar, Microsoft Outlook calendar, and similar platforms. The calendar projecting device 100 also retrieves calendar events such as appointments, reminders, tasks, and holidays from the received calendars.

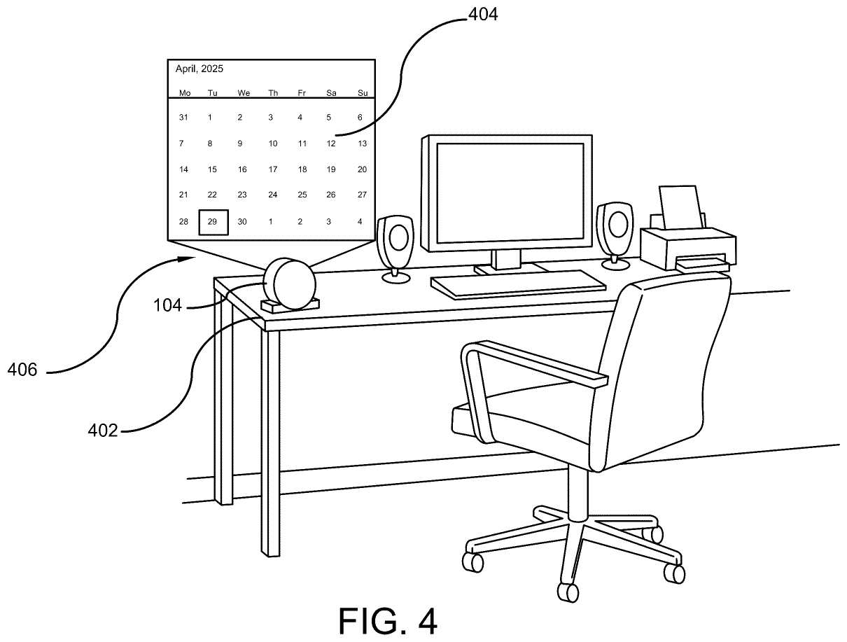

FIG. 4 illustrates a perspective view showing a digital calendar being displayed by the calendar projecting device of the present invention in accordance with the disclosed structure. The device 100 is lightweight, portable, and can be placed on a work desk 402 for easy accessibility and use. The device 100 can receive a calendar for projection from a remote device as described in FIG. 2, or can also generate as a standalone calendar. As illustrated, a projected calendar 404 is displayed on wall 406, wherein the calendar 404 is projected by the device 100. The projected calendar 404 can be customized as per preferences of a user using voice commands or companion software application. It is to be appreciated that the digital calendar displays a date and entry items selected from the group consisting of a meeting, an appointment, an event, a reminder, a deadline, a commitment, a ‘to do’ item, a task, a holiday, a birthday, an anniversary, a time, and more. The device enables users to program (i.e., add, modify, and/or delete entry items) the calendar via software on a smartphone, laptop, or other smart devices, and/or through voice commands or other data entry. It is to be appreciated that the programming includes adding (or modifying and deleting) entry items as reoccurring items. For example, birthdays and anniversaries can be entered and programmed as reoccurring annual event items to be scheduled and displayed on future calendars.

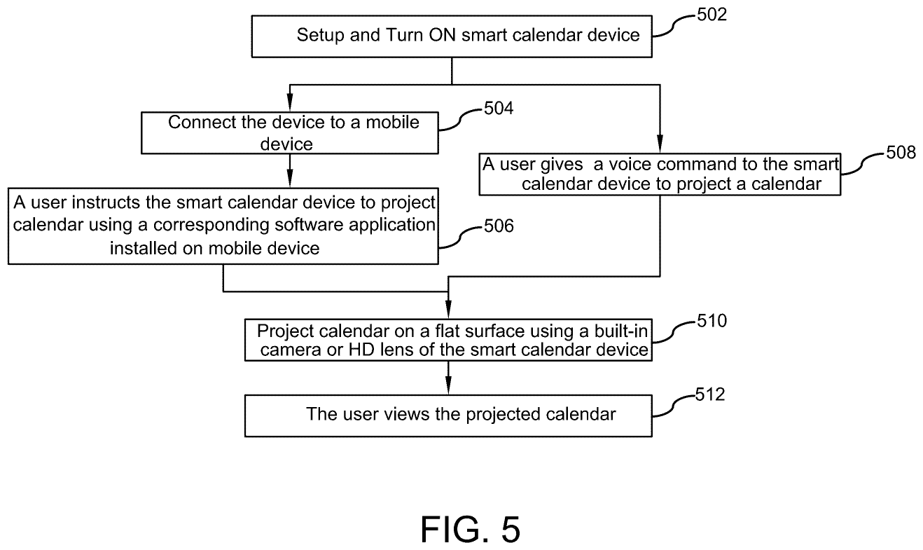

FIG. 5 illustrates a flow chart depicting a process of use of the calendar projecting device in accordance with the disclosed structure. Initially, a user sets up and powers on the smart calendar device 100. The starting up of the device may involve initial configuration, charging or plugging in the device, and enabling wireless connectivity (Step 502). For using the device 100, in step 504, the smart calendar device 100 is connected wirelessly to a mobile device, such as a smartphone or tablet, using Bluetooth, Wi-Fi, or a similar wireless communication protocol. After wireless connection, the user instructs the smart calendar device to project a calendar using the software application installed on the connected mobile device. The software application may enable users to customize the type of calendar view (i.e., daily, weekly, monthly, yearly), theme, and preferred projection surface (Step 506). Alternatively, the user may issue a voice command directly to the smart calendar device, instructing it to project the calendar. Voice command processing may be handled by a built-in microphone and a natural language processing (NLP) module configured to interpret such commands (Step 508).

Upon receiving the instruction (via app or voice), the smart calendar device projects the digital calendar onto a flat or planar surface using the built-in HD lens and camera-based micro-projector module. The projection may be adjusted based on lighting conditions and surface orientation (Step 510). Finally, in step 512, the user views the projected calendar, which may include synchronized content from a paired digital calendar application such as Google Calendar, Apple Calendar, or Outlook.

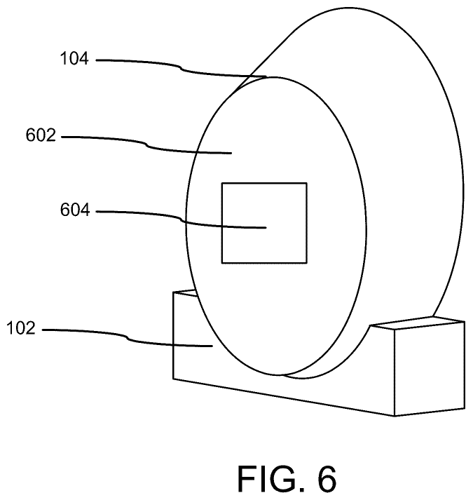

FIG. 6 illustrates a rear view of the calendar projecting device of the present invention in accordance with the disclosed structure. The rear surface 602 of the main body 102 may include a wireless charger surface 604 for wirelessly charging the device 100 for operation. Further, the main body 104 is detachable from the base 102, and the base 102 can come in different shape for compatibility with the main body 104.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “digital calendar projecting device, “calendar projecting device”, “smart calendar device”, and “device” are interchangeable and refer to the calendar projecting device 100 of the present invention.

Notwithstanding the foregoing, the calendar projecting device 100 of the present invention can be of any suitable configuration as is known in the art without affecting the overall concept of the invention, provided that it accomplishes the above-stated objectives. One of ordinary skill in the art will appreciate that the calendar projecting device 100 as shown in the FIGS. are for illustrative purposes only, and that many other configurations of the calendar projecting device 100 are well within the scope of the present disclosure. Although the dimensions of the calendar projecting device 100 are important design parameters for user convenience, the calendar projecting device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A digital calendar projecting device comprising:
a portable digital calendar projecting device having a main body;
a stand;
a projection lens;
a microphone; and
an electronic computing device;
wherein said portable digital calendar projecting device paired wirelessly with at least one of said electronic computing device for receiving calendar information;
wherein said portable digital calendar projecting device projecting said calendar information;
wherein said stand is a base to keep said portable digital calendar projecting device stable on a horizontal surface;
wherein said main body mountable to said base;
wherein said projection lens is a high-definition lens for high-definition (HD) projections;
wherein said HD projections are calendar images of said calendar information;
wherein said calendar information is information including a date and entry items selected from the group consisting of one or more of a meeting, an appointment, an event, a reminder, a deadline, a commitment, a ‘to do’ item, a task, a holiday, a birthday, an anniversary, and a time; and
further wherein said calendar information is received from a source selected from the group consisting of an input from said electronic computing device and a voice command from said microphone.

2. The digital calendar projecting device of claim 1, wherein said input adds, modifies, or deletes said calendar information in a form selected from the group consisting of a reoccurring entry item and a single entry item.

3. The digital calendar projecting device of claim 1, wherein said voice command adds, modifies, or deletes said calendar information in a form selected from the group consisting of a reoccurring entry item and a single entry item.

4. The digital calendar projecting device of claim 2, wherein said projection lens is adjustable using an adjustable cap for adjusting focus and angle to project said calendar images on a planar surface.

5. The digital calendar projecting device of claim 4, wherein said projection lens operatively coupled to a micro-projector module for projecting said calendar information onto a planar surface.

6. The digital calendar projecting device of claim 3, wherein said portable digital calendar projecting device having a natural language processing module for interpreting said voice commands received from said microphone.

7. The digital calendar projecting device of claim 6, wherein said calendar information is a view selected from the group consisting of a daily view, a weekly view, a monthly view, and a yearly view.

8. The digital calendar projecting device of claim 7, wherein said portable digital calendar projecting device having a wireless module for receiving said input from said electronic computing device.

9. The digital calendar projecting device of claim 8, wherein said input is integrated with a calendar application selected from the group consisting of a Google Calendar, an Outlook calendar, and an Apple Calendar.

10. A digital calendar projecting device comprising:
a portable digital calendar projecting device having a main body;
a stand;
a projection lens;
a microphone; and
an electronic computing device;
wherein said portable digital calendar projecting device paired wirelessly with at least one of said electronic computing device for receiving calendar information;
wherein said portable digital calendar projecting device projecting said calendar information;
wherein said stand is a base to keep said portable digital calendar projecting device stable on a horizontal surface;
wherein said main body mountable to said base;
wherein said projection lens is a high-definition lens for high-definition (HD) projections;
wherein said HD projections are calendar images of said calendar information;
wherein said calendar information is information including a date and entry items selected from the group consisting of one or more of a meeting, an appointment, an event, a reminder, a deadline, a commitment, a ‘to do’ item, a task, a holiday, a birthday, an anniversary, and a time;
wherein said calendar information is received from a source selected from the group consisting of an input from said electronic computing device and a voice command from said microphone; and
further wherein said portable digital calendar projecting device having a natural language processing module for interpreting said voice commands received from said microphone.

11. The digital calendar projecting device of claim 10, wherein said input adds, modifies, or deletes said calendar information in a form selected from the group consisting of a reoccurring entry item and a single entry item.

12. The digital calendar projecting device of claim 10, wherein said voice command adds, modifies, or deletes said calendar information in a form selected from the group consisting of a reoccurring entry item and a single entry item.

13. The digital calendar projecting device of claim 10, wherein said projection lens is adjustable using an adjustable cap for adjusting focus and angle to project said calendar images on a planar surface.

14. The digital calendar projecting device of claim 10, wherein said projection lens operatively coupled to a micro-projector module for projecting said calendar information onto a planar surface.

15. The digital calendar projecting device of claim 10, wherein said calendar information is a view selected from the group consisting of a daily view, a weekly view, a monthly view, and a yearly view.

16. The digital calendar projecting device of claim 10, wherein said portable digital calendar projecting device having a wireless module for receiving said input from said electronic computing device.

17. The digital calendar projecting device of claim 10, wherein said input is integrated with a calendar application selected from the group consisting of a Google Calendar, an Outlook calendar, and an Apple Calendar.

18. A method of projecting a digital calendar, the method comprising the steps of:
providing a portable digital calendar projecting device having a main body, a stand, a projection lens, a microphone, and an electronic computing device, wherein said stand is a base to keep said portable digital calendar projecting device stable on a horizontal surface;
pairing said portable digital calendar projecting device wirelessly with at least one of said electronic computing device for receiving calendar information;
mounting said main body to said base;
projecting said calendar information with said portable digital calendar projecting device onto a planar surface;
wherein said projection lens is a high-definition lens for high-definition (HD) projections;
wherein said HD projections are calendar images of said calendar information;
wherein said calendar information is information including a date and entry items selected from the group consisting of one or more of a meeting, an appointment, an event, a reminder, a deadline, a commitment, a ‘to do’ item, a task, a holiday, a birthday, an anniversary, and a time;
receiving said calendar information from a source selected from the group consisting of an input from said electronic computing device and a voice command from said microphone, wherein said portable digital calendar projecting device having a natural language processing module for interpreting said voice commands received from said microphone; and
storing said calendar information in a memory of said electronic computing device.

19. The method of projecting a digital calendar of claim 18, wherein said input adds, modifies, or deletes said calendar information in a form selected from the group consisting of a reoccurring entry item and a single entry item, and further wherein said input is integrated with a calendar application selected from the group consisting of a Google Calendar, an Outlook calendar, and an Apple Calendar.

20. The method of projecting a digital calendar of claim 18, wherein said calendar information is a view selected from the group consisting of a daily view, a weekly view, a monthly view, and a yearly view, and further wherein said portable digital calendar projecting device having a wireless module for receiving said input from said electronic computing device.
